(19) United States
(12) Patent Application Publication
(10) Pub. No.: US 2020/0100599 A1
(43) Pub. Date: Apr. 2, 2020

(54) PUMP AND VALVE COMBINATION FOR BLADDER ADJUSTMENT

(71) Applicant: KOGE MICRO TECH CO., LTD., New Taipei City (TW)

(72) Inventors: Chih CHANG, New Taipei City (TW); Qing-Xiang XU, New Taipei City (TW)

(21) Appl. No.: 16/560,220

(22) Filed: Sep. 4, 2019

(30) Foreign Application Priority Data
Sep. 27, 2018 (CN) 201811131588.9

(51) Int. Cl. A47C 27/08; B60N 2/90; B60N 2/66; A47C 7/46

(52) U.S. Cl. CPC A47C 27/082; A47C 7/467; B60N 2/665; B60N 2/914

(57) ABSTRACT

A pump and valve combination used for bladder adjustment and composed of a valve member communicating with bladders and a fluid supply member is revealed. The valve member consists of a valve cap, at least one solenoid operated directional control valve in the valve cap, and at least one air supply tube in the valve cap. The fluid supply member with at least one air supply port is arranged under the valve member while the valve cap is fixed on one end of the fluid supply member. An air input end and an air output end of the air supply tube are connected to the air supply port and an input portion of the solenoid operated directional control valve respectively while an output portion of the solenoid operated directional control valve is connected to the bladder. No check valve is disposed in the valve member.

### BACKGROUND OF THE INVENTION

### 1. Technical Field

The present invention relates to a pump and valve combination for bladder adjustment, especially to a pump and valve combination which uses fluid for adjustment of bladders. For example, the pump and valve combination can be applied to at least one part of seats, beds, etc.

### 2. Description of Related Art

For the comfort of users, seats available now are often provided with lumbar supports or adjustable supports for other areas of the body. For example, the backrest is provided with the lumbar support that forms a suitable support surface for supporting users' lumbar spine. The lumbar support can be a support based on components able to be moved mechanically or a support with at least one inflatable chamber with fluid therein. The inflatable chamber is provided with inflatable air cushions or bladders whose shape and size are adjustable along with the volume of the fluid therein.

The space in the seats available for installation of other parts is limited. Thus there is room for improvement and there is a need to provide a pump and valve combination in which a plurality of adjustable members is integrated into one piece for decreasing assembly cost and increasing seat comfort without occupying too much space while being mounted into the seat.

### SUMMARY OF THE INVENTION

Therefore it is a primary object of the present invention to provide a pump and valve combination for bladder adjustment in which a plurality of adjustable members is integrated into one piece so that not space occupied is minimized and assembly cost is reduced.

The present invention provides a pump and valve combination for bladder adjustment comprising: a valve member which is communicating with at least one bladder and including a valve cap, at least one solenoid operated directional control valve mounted in the valve cap, and at least one air supply tube arranged in the valve cap; and a fluid supply member which is connected to the bottom of the valve member and provided with at least one air supply port; wherein the valve cap is connected to one end of the fluid supply member; an air input end of the air supply tube is connected to the air supply port and an air output end of the air supply tube is connected to an input portion of the solenoid operated directional control valve while an output portion of the solenoid operated directional control valve is connected to the bladder. The valve member is not provided with any check valve.

Preferably, the valve cap includes at least one pipe hole and the output portion of the solenoid operated directional control valve is exposed through the pipe hole.

Preferably, the valve member further includes an electronic control part which is electrically connected to at least one solenoid operated directional control valve. The electronic control part controls the fluid supply member for supplying gas to the valve member.

Preferably, the valve cap is further provided with an electrical interface while the electronic control part includes a terminal set which is located in the electrical interface.

Preferably, a stopping portion is formed around the air supply tube. The stopping portion is projecting from the air supply tube and disposed around the air supply port of the fluid supply member.

Preferably, at least one limiting slot is formed on the electronic control part for limiting the air supply tube therein. The stopping portion of the air supply tube is arranged between the limiting slot and the air supply port of the fluid supply member.

Preferably, the solenoid operated directional control valve further includes an adjustment outlet through which fluid in the bladder is discharged to the atmosphere.

Preferably, the adjustment outlet of the solenoid operated directional control valve is located inside the valve cap.

Preferably, the pump and valve combination for bladder adjustment includes a pair of solenoid operated directional control valves and a pair of air supply tubes while the fluid supply member includes a pair of air supply ports.

The present invention provides a pump and valve combination for bladder adjustment comprising: a valve member which is communicating with at least one bladder and including a valve cap, at least one solenoid operated directional control valve mounted in the valve cap, and at least one air supply tube arranged in the valve cap; and a fluid supply member which is connected to the bottom of the valve member and provided with at least one air supply port; wherein the valve cap is connected to one end of the fluid supply member; an air input end of the air supply tube is connected to the air supply port and an air output end of the air supply tube is connected to an input portion of the solenoid operated directional control valve while an output portion of the solenoid operated directional control valve is connected to the bladder. The fluid supply member is provided at least one check valve which is disposed on top of the air supply port.

Implementation of the present invention at least produces the following advantageous effects: a plurality of adjustable members is integrated into one pump and valve combination so as to reduce not only the space occupied but also the assembly cost.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment of a pump and valve combination connected to bladders according to the present invention;

FIG. 2 is a perspective view of an embodiment of a pump and valve combination according to the present invention;

FIG. 3 is a partial explosive view of an embodiment of a pump and valve combination according to the present invention;

FIG. 4 is a partial assembled view of an embodiment of a pump and valve combination according to the present invention;

FIG. 5 is a partial sectional view of an embodiment of a pump and valve combination according to the present invention;

FIG. 6 is a partial explosive view of a fluid supply member in an embodiment of a pump and valve combination according to the present invention;

FIG. 7 is another explosive view of a fluid supply member in an embodiment of a pump and valve combination according to the present invention;

FIG. 8 is a sectional view of the embodiment in FIG. 4 taken along line VIII-VIII of FIG. 4 according to the present invention;

FIG. 9 is a sectional view of the embodiment in FIG. 4 taken along line IX-IX of FIG. 4 according to the present invention; and

FIG. 10 is a sectional view of the embodiment in FIG. 4 taken along line X-X of FIG. 4 according to the present invention.

### DETAILED DESCRIPTION OF THE INVENTION

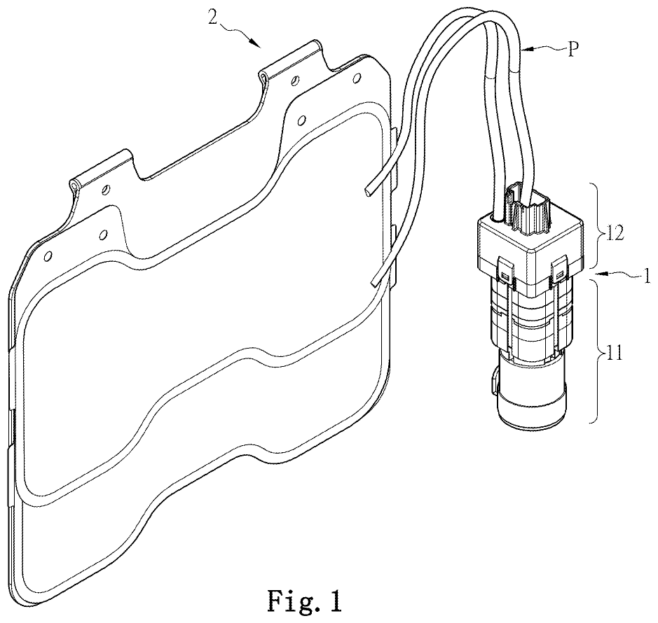

Refer to FIG. 1, a perspective view of a pump and valve combination 1 for bladder adjustment of the present invention being connected to bladders is revealed. The present pump and valve combination for bladder adjustment can be applied to seats such as vehicle seats for adjustment. For example, the bladder can be disposed on the seat back or seat lumber for support and adjustment. The pump and valve combination for bladder adjustment can also be arranged at massage chairs or beds for adjusting chairs or beds.

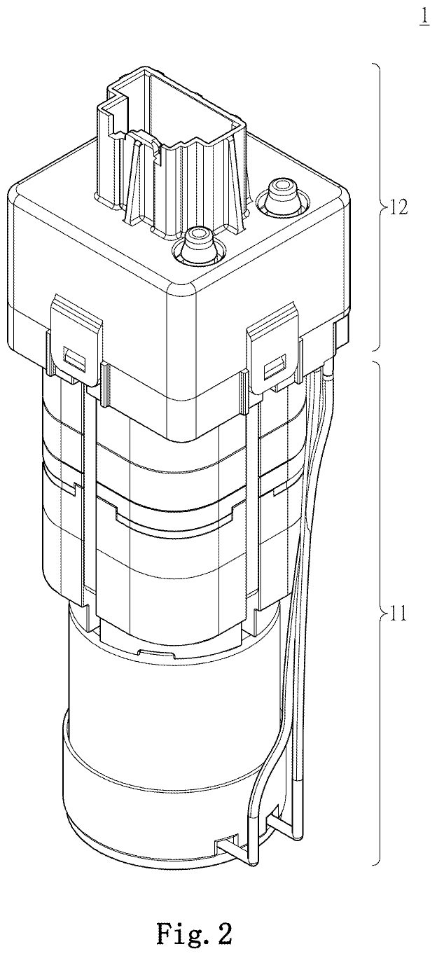

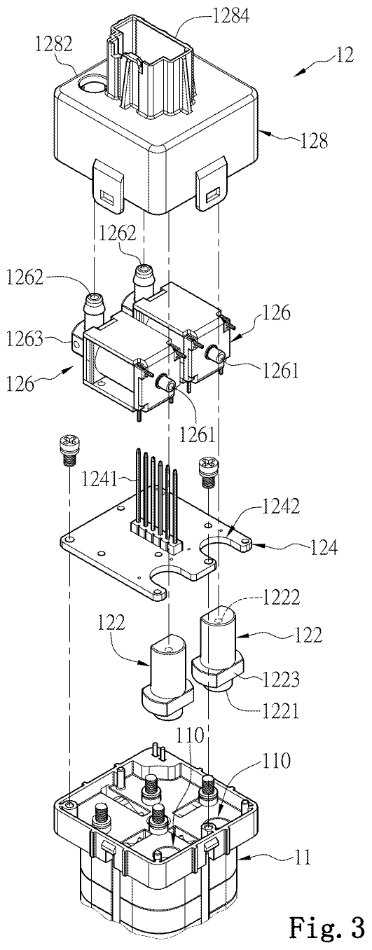

Refer to FIG. 2 and FIG. 3, the pump and valve combination 1 for bladder adjustment according to the present invention includes a valve member 12 and a fluid supply member 11. The valve member 12 is communicating with at least one bladder 2 and is composed of a valve cap 128, at least one solenoid operated directional control valve 126, and at least one air supply tube 122. The solenoid operated directional control valve 126 and the air supply tube 122 are mounted in the valve cap 128. The fluid supply member 11 provided with at least one air supply port 110 is connected to the bottom of the valve member 12 and used for supplying fluid. The fluid can be gas such as air. More precisely, the fluid supply member 11 can be a pump. The valve cap 128 is fixed on and connected to one end of the fluid supply member 11.

In this embodiment, the pump and valve combination 1 includes a pair of solenoid operated directional control valves 126 and a pair of air supply ports 122 while the fluid supply member 11 includes a pair of air supply ports 110.

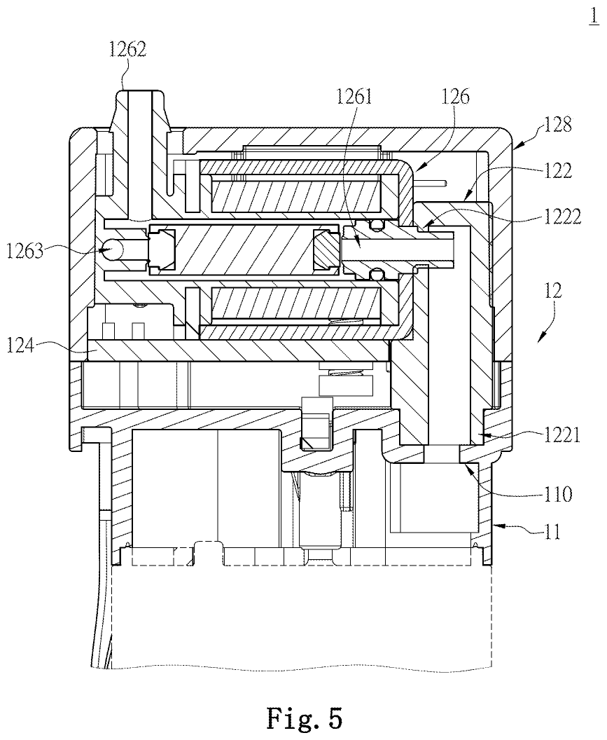

As shown in FIG. 5, an air input end 1221 of the air supply tube 122 is connected to the air supply port 110 and an air output end 1222 of the air supply tube 122 is connected to an input portion 1261 of the solenoid operated directional control valve 126 while an output portion 1262 of the solenoid operated directional control valve 126 is connected to the bladder 2. The valve member 12 is not provided with any check valve.

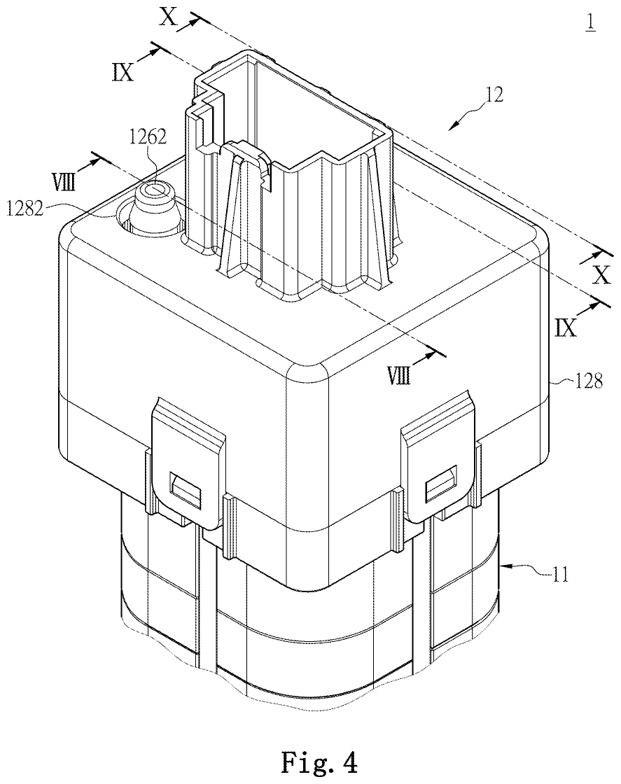

The valve cap 128 includes a pair of pipe holes 1282 and the output portion 1262 of the solenoid operated directional control valve 126 is exposed through the pipe hole 1282, as shown in FIG. 4.

In this embodiment, the valve member 12 further includes an electronic control part 124 which is electrically connected to at least one solenoid operated directional control valve 126. The electronic control part 124 is further electrically connected to the fluid supply member 11 for control of the fluid supply member 11 in order to supply gas to the valve member 12.

The solenoid operated directional control valve 126 further includes an adjustment outlet 1263 through which fluid in the bladder 2 is discharged to the atmosphere. The adjustment outlet 1263 of the solenoid operated directional control valve 126 is located inside the valve cap 128, as shown in FIG. 5. While the fluid/air is released from the bladder 2, the fluid/air is flowing in the valve cap 128 of the valve member 12 and passed through an electromagnetic coil therein. Thereby the flowing fluid/air helps cool down the solenoid operated directional control valve 126.

In this embodiment, the solenoid operated directional control valve 126 is provided with an actuator for adjusting gas flow during the adjustment process mentioned above. The actuator can be a solenoid, a piezo element, and so on.

Moreover, the electronic control part 124 controls time and duration the power being supplied to the actuator of the solenoid operated directional control valve 126. The electronic control part 124 can have additional functions. For example, the valve member 12 is provided with a pressure sensor for pressure measurement of the air in the bladder 2. The electronic control part 124 can be coupled to the pressure sensor for control of actuation of the fluid supply member 11 and the valve member 12 according to the value of the pressure measured. The valve member 12 further includes a storage in which preset pressure settings or preset actuation modes are stored. The electronic control part 124 controls the actuation of the fluid supply member 11 and the valve member 12 based on the preset pressure settings or preset actuation modes.

The valve cap 128 is further provided with an electrical interface 1284 while the electronic control part 124 includes a terminal set 1241 which is used for receiving signals and located in the electrical interface 1284. The electronic control part 124 is disposed to respond to the signals received for control of the fluid supply member 11 and the valve member 12. The electronic control part 124 can be mounted in the valve member 12. Thus, the assembly process of the pump and valve combination 1 on the product can be simplified.

A stopping portion 1223 is formed around the air supply tube 122. The stopping portion 1223 is projecting from the air supply tube 122 and arranged around the air supply port 110 of the fluid supply member 11.

At least one limiting slot 1242 is formed on the electronic control part 124 for limiting the air supply tube 122 therein. The stopping portion 1223 of the air supply tube 122 is arranged between the limiting slot 1242 and the air supply port 110 of the fluid supply member 11. Thereby the air supply tube 122 is fixed in the pump and valve combination 1 easily.

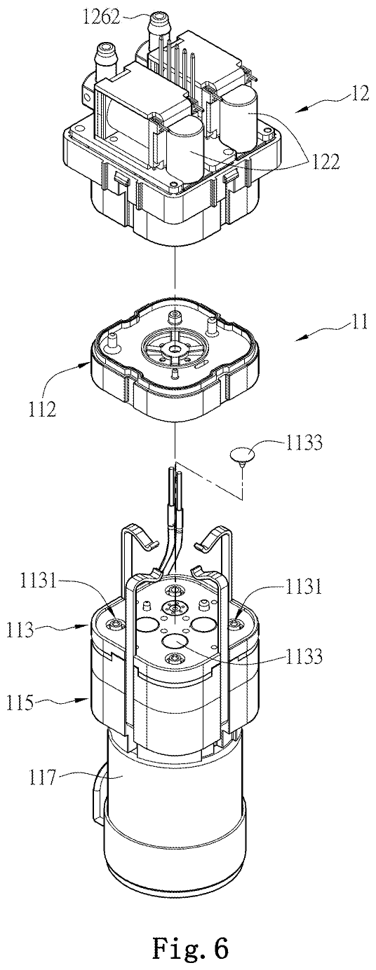

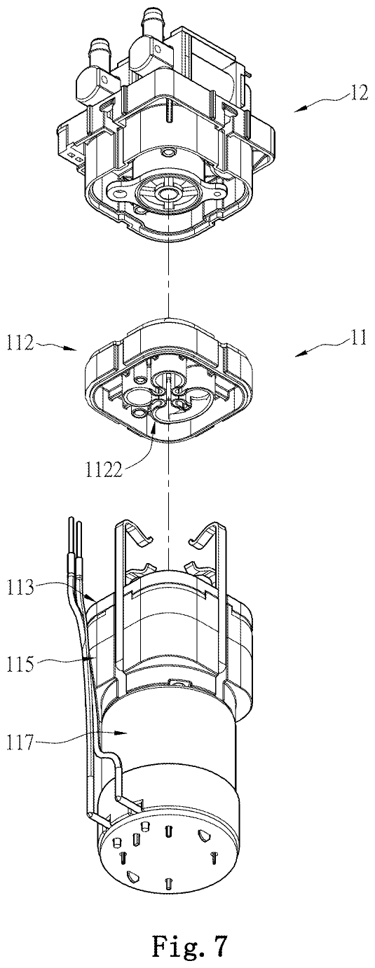

Refer to FIG. 6 and FIG. 7, a preferred embodiment is revealed. The fluid supply member 11 is composed of an adapter 112, a valve base 113, a diaphragm assembly 115 and a motor 117. The adapter 112 is connected to the bottom of the valve member 12 and having a gas regulation chamber 1122. The valve base 113 composed of a plurality of air-supply check valves 1131 and a plurality of check valves 1133 is connected between the adapter 112 and the diaphragm assembly 115. A plurality of bell-shaped diaphragm parts 1151 is mounted in the diaphragm assembly 115 and is driven by the motor 117 for repeatedly pumping and pushing the gas.

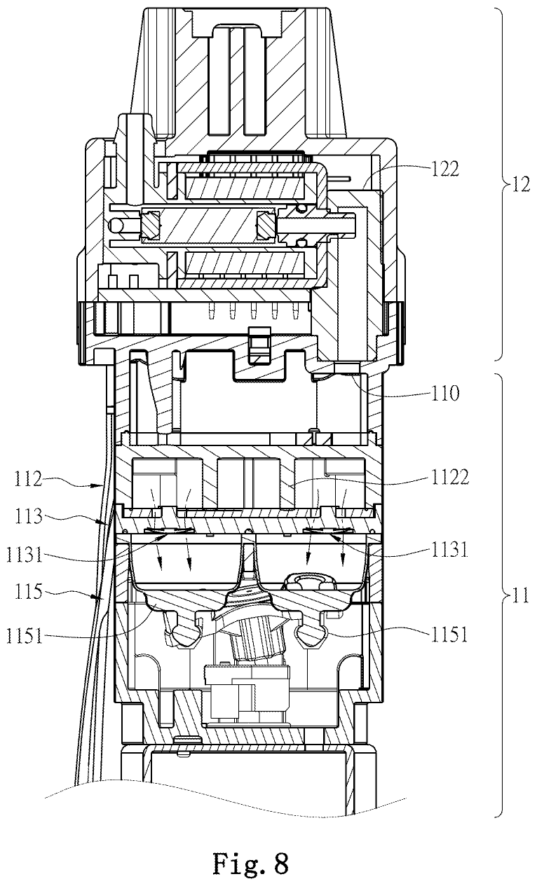

As shown in FIG. 8, the gas is sucked into the diaphragm assembly 115 in only one direction under control of the air-supply check valves 1131 of the valve base 113. In this embodiment, the gas passes through the periphery of the gas regulation chamber 1122 of the adapter 112 and then flows into the diaphragm assembly 115.

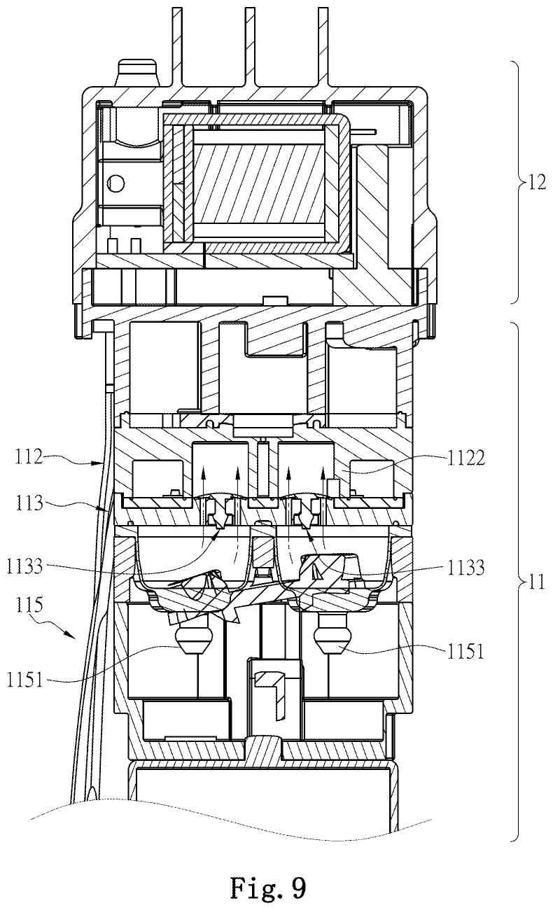

Refer to FIG. 9, the diaphragm parts 1151 of the diaphragm assembly 115 pushes the gas to pass through the check valves 1133 and the adapter 112 and then flow into the air supply tube 122 of the valve member 12. In this embodiment, the gas flows into the diaphragm assembly 115 through internal space of the gas regulation chamber 1122 of the adapter 112.

In this embodiment, the check valves 1133 are disposed on the top of the fluid supply member 11 and used for allowing fluid to flow from the fluid supply member 11 to the valve member 12 and blocking fluid flow in the reverse direction.

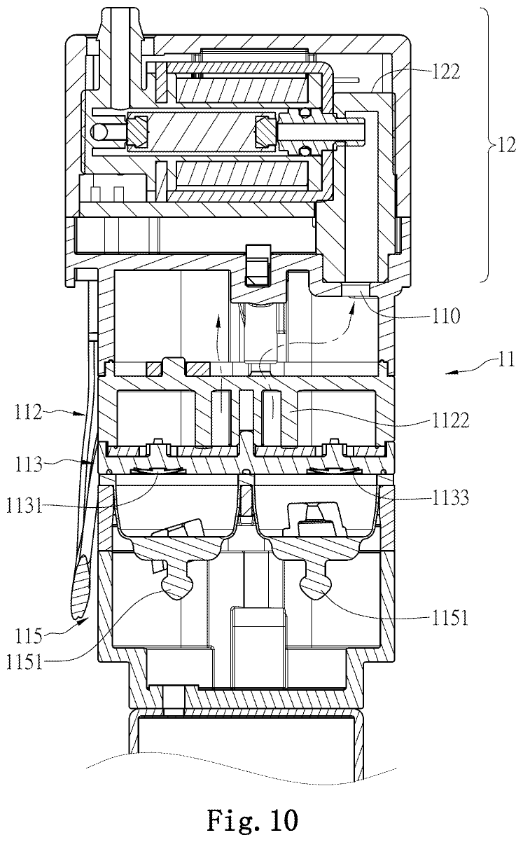

As shown in FIG. 10, the gas passes through the gas adjustment chamber 1122 of the adapter 112, changes the direction and flows into the valve member 12.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A pump and valve combination for bladder adjustment comprising:
a valve member which is communicating with at least one bladder and including
a valve cap,
at least one solenoid operated directional control valve mounted in the valve cap, and
at least one air supply tube arranged in the valve cap; and
a fluid supply member which is connected to the bottom of the valve member and provided with at least one air supply port;
wherein the valve cap is connected to one end of the fluid supply member; an air input end of the air supply tube is connected to the air supply port and an air output end of the air supply tube is connected to an input portion of the solenoid operated directional control valve while an output portion of the solenoid operated directional control valve is connected to the bladder.

2. The pump and valve combination for bladder adjustment as claimed in claim 1, wherein the valve cap is provided with at least one pipe hole through which the output portion of the solenoid operated directional control valve is exposed.

3. The pump and valve combination for bladder adjustment as claimed in claim 1, wherein the valve member further includes an electronic control part which is not only electrically connected to the solenoid operated directional control valve but also electrically connected to the fluid supply member for control of the fluid supply member to supply gas to the valve member.

4. The pump and valve combination for bladder adjustment as claimed in claim 3, wherein the valve cap includes an electrical interface while the electronic control part includes a terminal set which is located in the electrical interface.

5. The pump and valve combination for bladder adjustment as claimed in claim 3, wherein a stopping portion is formed around the air supply tube; the stopping portion is projecting from the air supply tube and disposed around the air supply port of the fluid supply member.

6. The pump and valve combination for bladder adjustment as claimed in claim 5, wherein at least one limiting slot is formed on the electronic control part for limiting the air supply tube therein while the stopping portion of the air supply tube is arranged between the limiting slot and the air supply port of the fluid supply member.

7. The pump and valve combination for bladder adjustment as claimed in claim 1, wherein the solenoid operated directional control valve further includes an adjustment outlet through which fluid in the bladder is discharged to the atmosphere.

8. The pump and valve combination for bladder adjustment as claimed in claim 7, wherein the adjustment outlet of the solenoid operated directional control valve is located inside the valve cap.

9. The pump and valve combination for bladder adjustment as claimed in claim 1, wherein the pump and valve combination for bladder adjustment includes a pair of the solenoid operated directional control valves and a pair of the air supply tubes while the fluid supply member includes a pair of the air supply ports.

10. A pump and valve combination for bladder adjustment comprising:
a valve member which is communicating with at least one bladder and including
a valve cap,
at least one solenoid operated directional control valve mounted in the valve cap, and
at least one air supply tube arranged in the valve cap; and
a fluid supply member which is connected to the bottom of the valve member and provided with at least one diaphragm assembly;
wherein the valve cap is connected to one end of the fluid supply member; an air input end of the air supply tube is communicating with the diaphragm assembly and an air output end of the air supply tube is connected to an input portion of the solenoid operated directional control valve while an output portion of the solenoid operated directional control valve is connected to the bladder; at least one check valve is arranged at the fluid supply member; wherein gas being compressed by the diaphragm assembly passes the check valve and the air supply tube, then flows into the input portion of the solenoid operated directional control valve

11. The pump and valve combination for bladder adjustment as claimed in claim 10, wherein the fluid supply member includes an adapter, a valve base, the diaphragm assembly and a motor; the adapter is connected to the bottom of the valve member and having a gas regulation chamber; the valve base which is connected between the adapter and the diaphragm assembly includes a plurality of air-supply check valves and a plurality of the check valves; a plurality of diaphragm parts is mounted in the diaphragm assembly and is driven by the motor for repeatedly pumping and pushing the gas; wherein the gas is sucked into the diaphragm assembly in only one direction under control of the air-supply check valves of the valve base; the gas passes through the periphery of the gas regulation chamber of the adapter and then flows into the diaphragm assembly; the diaphragm parts of the diaphragm assembly pushes the gas to pass through the check valves and the adapter and flow into the air supply tube of the valve member; wherein the gas passes through the gas adjustment chamber of the adapter, changes the direction and flows into the valve member.
